(19) United States
(12) Patent Application Publication
(10) Pub. No.: US 2025/0191342 A1
(43) Pub. Date: Jun. 12, 2025

(54) LEARNING DEVICE AND METHOD THEREOF

(71) Applicants: HYUNDAI MOTOR COMPANY, Seoul (KR); KIA CORPORATION, Seoul (KR)

(72) Inventors: Hyun Kook Park, Seoul (KR); Jae Yoon Lee, Seoul (KR); Jun Yong Choi, Seongnam-si (KR); Jae Hyeon Park, Seoul (KR); Jae Hoon Cho, Seoul (KR)

(73) Assignees: HYUNDAI MOTOR COMPANY, Seoul (KR); KIA CORPORATION, Seoul (KR)

(21) Appl. No.: 18/638,952

(22) Filed: Apr. 18, 2024

(30) Foreign Application Priority Data
Dec. 8, 2023 (KR) 10-2023-0178074

(51) Int. Cl. G06V 10/774; G06N 3/094; G06T 11/00; G06V 10/75; G06V 10/82

(52) U.S. Cl. CPC G06V 10/774; G06N 3/094; G06T 11/00; G06V 10/75; G06V 10/82

(57) ABSTRACT

A learning device includes a processor and a memory. The processor is configured to obtain first rain streak information indicating first rain intensity from a first generative neural network to which a real image representing fine weather and noise data are input. The processor is also configured to obtain second rain streak information indicating second rain intensity with a higher level than the first rain intensity from a second generative neural network to which the obtained first rain streak information and the real image are input. The processor is additionally configured to generate a composite image in which a rain streak representing the second rain intensity is applied to the real image, using the real image and the obtained second rain streak information.

### CROSS-REFERENCE TO RELATED APPLICATION

This application claims the benefit of and priority to Korean Patent Application No. 10-2023-0178074, filed on Dec. 8, 2023, the entire contents of which are incorporated herein by reference.

### TECHNICAL FIELD

The present disclosure relates to a learning device and a method thereof.

### BACKGROUND

Recently, with the development of deep neural network-based computer vision technology in an autonomous driving technology, various artificial intelligence models, such as object detection, semantic segmentation, depth estimation, and lane detection, have been studied. Such an artificial intelligence model may perform supervised learning for large datasets constructed by obtaining a road image and performing labeling for matching the obtained image with a goal of each model, thus obtaining successful performance improvement. In this regard, a dataset for training the artificial intelligence model is constructed with respect to autonomous driving in a daytime environment by an artificial intelligence-based autonomous driving technology which is currently being studied. However, in order for the autonomous driving technology to be applied in rainy weather environments as well as fine weather environments, datasets composed of rainy weather images should be constructed.

A lot of money and time may be consumed in the process of constructing datasets indicating the rainy weather environment as well as constructing datasets indicating the fine weather environment in this process.

### SUMMARY

The present disclosure has been made to solve the above-mentioned problems occurring in the prior art while advantages achieved by the prior art are maintained intact.

An aspect of the present disclosure provides a learning device for generating a composite image representing rainy weather from a real image representing fine weather, and a method thereof.

Another aspect of the present disclosure provides a learning device for generating a composite image representing rainy weather based on different rain streaks by using label data of a real image representing fine weather, and a method thereof.

Another aspect of the present disclosure provides a learning device for training generative neural networks based on multi-generative adversarial networks (multi-GAN) to generate different rain streaks, and a method thereof.

The technical problems to be solved by the present disclosure are not limited to the aforementioned problems. Other technical problems not mentioned herein should be clearly understood from the following description by those having ordinary skill in the art to which the present disclosure pertains.

According to an aspect of the present disclosure, a learning device is provided. The learning device includes a processor and a memory operably connected to the processor. The processor is configured to obtain first rain streak information indicating first rain intensity from a first generative neural network to which a real image representing fine weather and noise data are input. The processor is also configured to obtain second rain streak information indicating second rain intensity with a higher level than the first rain intensity from a second generative neural network to which the obtained first rain streak information and the real image are input. The processor is further configured to generate a composite image in which a rain streak representing the second rain intensity is applied to the real image, using the real image and the obtained second rain streak information.

In an embodiment, the real image may include a first real image. In an embodiment, the composite image may include a first composite image. In an embodiment, the rain streak may include at least one first rain streak representing the first rain intensity. In an embodiment, the processor may be further configured to generate a second composite image in which the at least one first rain streak is applied to the first real image, using the real image and the obtained first rain streak information. The processor may be further still configured to obtain a first discrimination score indicating whether the second composite image is obtained based on the first generative neural network, from a first discriminative neural network trained using a second real image representing rainy weather distinct to the fine weather. The processor may be additionally configured to perform adversarial training for the first generative neural network, using the first discrimination score.

In an embodiment, the processor may be configured to obtain a second discrimination score for determining whether the first composite image is obtained based on the second generative neural network, from a second discriminative neural network trained using a third real image representing another rainy weather distinct to the rainy weather. The processor may also be configured to perform adversarial training for the second generative neural network, using the second discrimination score.

In an embodiment, the second real image may be obtained based on upsampling a downsampled third real image, after the third real image is downsampled.

In an embodiment, the noise data may include data for obtaining the first composite image corresponding to the first real image. In an embodiment, the processor may be configured to generate the first rain streak information, based on residual learning using the first generative neural network to which the noise data is input together with the first real image.

In an embodiment, the processor may be configured to identify an object in the first real image, based on inputting the first real image to the first generative neural network, obtain object rain streak information matched with the identified object in the first rain streak information. The processor may also be configured to generate the second composite image including at least a portion of feature information included in the first real image, based on obtaining the object rain streak information.

In an embodiment, the second generative neural network may be trained to generate at least one second rain streak with a smaller size than the at least one first rain streak between the at least one first rain streak and the at least one second rain streak, using the first rain streak information.

In an embodiment, the processor may be configured to obtain the second rain streak information including the at least one first rain streak and at least one second rain streak with a smaller size than the at least one first rain streak, based on inputting the first rain streak information obtained from the first generative neural network to the second generative neural network.

In an embodiment, the processor may be configured to obtain third rain streak information including at least one third rain streak with a smaller size than the at least one second rain streak from a third generative neural network to which the real image and the second rain streak information are input.

In an embodiment, the second rain intensity may have a higher level than the first rain intensity, based on representing the rain streak with a rain streak number greater than a number of rain streaks corresponding to the first rain intensity.

According to another aspect of the present disclosure, a learning method is provided. The learning method includes obtaining first rain streak information indicating first rain intensity from a first generative neural network to which a real image representing fine weather and noise data are input. The learning method also includes obtaining second rain streak information indicating second rain intensity with a higher level than the first rain intensity from a second generative neural network to which the obtained first rain streak information and the real image are input. The learning method additionally includes generating a composite image in which a rain streak representing the second rain intensity is applied to the real image, using the real image and the obtained second rain streak information.

In an embodiment, the real image may include a first real image. In an embodiment, the composite image may include a first composite image. In an embodiment, the rain streak may include at least one first rain streak representing the first rain intensity. In an embodiment, the learning method may further include generating a second composite image in which the at least one first rain streak is applied to the first real image, using the real image and the obtained first rain streak information. The learning method may also include obtaining a first discrimination indicating whether the second composite image is obtained based on the first generative neural network, from a first discriminative neural network trained using a second real image representing rainy weather distinct to the fine weather. The learning method may additionally include performing adversarial training for the first generative neural network, using the first discrimination score.

In an embodiment, the learning method may further include obtaining a second discrimination score for determining whether the first composite image is obtained based on the second generative neural network, from a second discriminative neural network trained using a third real image representing another rainy weather distinct to the rainy weather. The learning method may additionally include performing adversarial training for the second generative neural network, using the second discrimination score.

In an embodiment, the second real image may be obtained based on upsampling a downsampled third real image, after the third real image is downsampled.

In an embodiment, the noise data may include data for obtaining the first composite image corresponding to the first real image. Obtaining the first rain streak information may include generating the first rain streak information between the second composite image and the first rain streak information, based on residual learning using the first generative neural network to which the noise data is input together with the first real image.

In an embodiment, the learning method may further include identifying an object in the first real image, based on inputting the first real image to the first generative neural network. The learning method may also include obtaining object rain streak information matched with the identified object in the first rain streak information. The learning method may additionally include generating the second composite image including at least a portion of feature information included in the first real image, based on obtaining the object rain streak information.

In an embodiment, the second generative neural network may be trained to generate at least one second rain streak with a smaller size than the at least one first rain streak between the at least one first rain streak and the at least one second rain streak, using the first rain streak information.

In an embodiment, obtaining the second rain streak information may include obtaining the second rain streak information including the at least one first rain streak and at least one second rain streak with a smaller size than the at least one first rain streak, based on inputting the first rain streak information obtained from the first generative neural network to the second generative neural network.

In an embodiment, the learning method may further include obtaining third rain streak information indicating at least one third rain streak with a smaller size than the at least one second rain streak from a third generative neural network to which the real image and the second rain streak information are input.

In an embodiment, the second rain intensity may have a higher level than the first rain intensity, based on representing the rain streak with a rain streak number greater than a number of rain streaks corresponding to the first rain intensity.

### BRIEF DESCRIPTION OF THE DRAWINGS

The above and other objects, features and advantages of the present disclosure should be more apparent from the following detailed description taken in conjunction with the accompanying drawings, in which:

FIG. 1 is a block diagram of an example learning device, according to an embodiment of the present disclosure;

FIG. 2 illustrates an example for describing a neural network obtained from a set of parameters stored in a memory by a learning device, according to an embodiment of the present disclosure;

FIG. 3 is a schematic block diagram of an example learning device, according to an embodiment of the present disclosure;

FIG. 4 illustrates an example of a generative neural network and a discriminative neural network in a learning device, according to an embodiment of the present disclosure;

FIG. 5 illustrates an example of an operation for obtaining a real image indicating rainy weather in a learning device, according to an embodiment of the present disclosure;

FIG. 6 illustrates an example for describing a configuration of a generative neural network, in an embodiment;

FIG. 7 illustrates an example for describing a configuration of a discriminative neural network, in an embodiment;

FIGS. 8A, 8B, and 8C illustrate an example of an operation for obtaining a composite image using a real image and rain streak information in a learning device, according to an embodiment of the present disclosure; and

FIG. 9 is a flowchart illustrating an example operation of a learning device, according to an embodiment of the present disclosure.

### DETAILED DESCRIPTION

Hereinafter, embodiments of the present disclosure are described in detail with reference to the accompanying drawings. It should be appreciated that various embodiments of the present disclosure and the terms used therein are not intended to limit the technological features set forth herein to particular embodiments. The present disclosure includes various changes, equivalents, or replacements for a corresponding embodiment described herein.

In adding the reference numerals to the components of each drawing, it should be noted that identical or equivalent components are designated by the identical numerals even when the components are displayed on different drawings. In addition, a detailed description of well-known features or functions has been omitted in order not to unnecessarily obscure the gist of the present disclosure.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art, and should not to be interpreted as having ideal or excessively formal meanings unless clearly defined as having such in the present disclosure.

The term “module” used in various embodiments of the present disclosure may include a unit implemented with hardware, software, or firmware, and may be interchangeably used with terms, for example, “logic,” “logic block,” “part,” or “circuitry”. A module may be an integral part, or a minimum unit or portion thereof, adapted to perform one or more functions. In an embodiment, the module may be implemented in the form of an application-specific integrated circuit (ASIC). According to various embodiments, operations performed by the module, the program, or another component may be carried out sequentially, in parallel, or repeatedly, or one or more of the operations may be executed in a different order or omitted, or one or more other operations may be added.

Various embodiments of the present disclosure may be implemented as software (e.g., a program) including one or more instructions stored in a storage medium (e.g., an internal memory or an external memory) readable by a machine (e.g., a vehicle control device 100). For example, a processor (e.g., a processor 110) of the device (e.g., the vehicle control device 100) may invoke at least one of the stored one or more instructions from the storage medium and may execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., an electromagnetic wave). This term does not differentiate between where data is semi-permanently stored in the storage medium and where data is temporarily stored in the storage medium.

When a component, device, element, or the like of the present disclosure is described as having a purpose or performing an operation, function, or the like, the component, device, or element should be considered herein as being “configured to” meet that purpose or perform that operation or function.

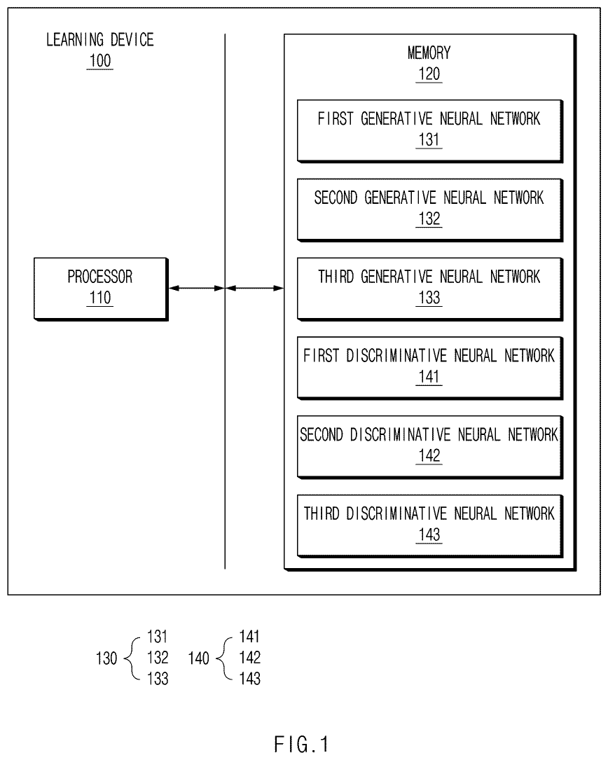

Hereinafter, embodiments of the present disclosure are described in detail with reference to FIGS. 1-9.

FIG. 1 is a block diagram of an example learning device, according to an embodiment of the present disclosure. Referring to FIG. 1, a learning device 100 according to an embodiment may include at least one of a processor 110 and a memory 120. The processor 110 and the memory 120 may be electronically or operably coupled with each other by an electronical component including a communication bus.

In the present disclosure, when it is described that pieces of hardware are operably coupled with each other, this may mean that a direct connection or an indirect connection between the pieces of hardware is established in a wired or wireless manner, such that second hardware is controlled by first hardware among the pieces of hardware. The different blocks are illustrated in FIG. 1, but embodiments of the present disclosure are not limited thereto. Some of the pieces of hardware of FIG. 1 may be included in a single integrated circuit including a system on a chip (SoC). Types of the pieces of hardware included in the learning device 100 or the number of the pieces of hardware are limited to those shown in FIG. 1. For example, the learning device 100 may include only some of the pieces of hardware shown in FIG. 1.

Components (e.g., layers, one or more generative neural networks 130, and/or one or more discriminative neural networks 140) in the memory 120, which are described in more detail below, may be in a logically divided state. However, the present disclosure is not limited thereto.

The processor 110 of the learning device 100 according to an embodiment may include a hardware component for processing data based on one or more instructions. The hardware component for processing the data may include, for example, an arithmetic and logic unit (ALU), a field programmable gate array (FPGA), and/or a central processing unit (CPU). The processor 110 may include one or more processors. For example, the processor 110 may have a structure of a multi-core processor such as a dual core, a quad core, or a hexa core.

The memory 120 of the learning device 100 may include a hardware component for storing data and/or instructions input and/or output from the processor 110. The memory 120 may include, for example, a volatile memory, such as a random-access memory (RAM), and/or a non-volatile memory, such as a read-only memory (ROM). The volatile memory may include at least one of, for example, a dynamic RAM (DRAM), a static RAM (SRAM), a cache RAM, or a pseudo SRAM (PSRAM). The non-volatile memory may include at least one of, for example, a programmable ROM (PROM), an erasable PROM (EPROM), an electrically erasable PROM (EEPROM), a flash memory, a hard disk, a compact disc, or an embedded multi-media card (eMMC).

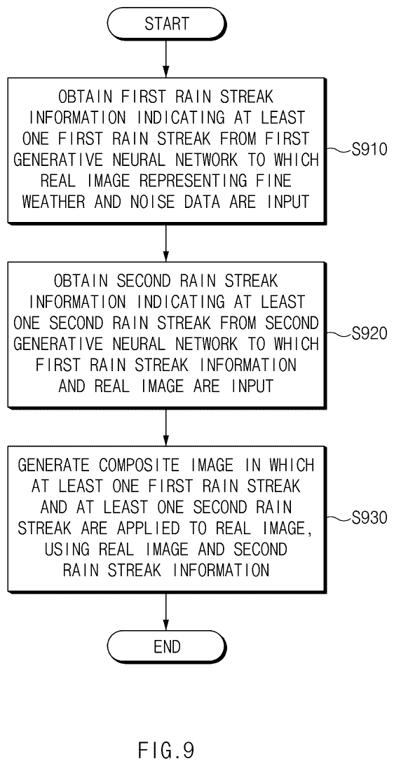

One or more instructions indicating calculations and/or other operations to be performed for data by the processor 110 of the learning device 100 may be stored in the memory 120 of the learning device 100, according to an embodiment. A set of the one or more instructions may be referred to as firmware, an operating system, a process, a routine, a sub-routine, and/or an application. For example, when a set of a plurality of instructions distributed in the form of an operating system, firmware, a driver, and/or an application is executed, the learning device 100 and/or the processor 110 may perform at least one of the operations described in more detail below with reference to FIG. 9.

A set of parameters associated with the generative neural network 130 and/or the discriminative neural network 140 may be stored in the memory 120 of the learning device 100, according to an embodiment. The generative neural network 130 and/or the discriminative neural network 140 may be a recognition model, implemented with software and/or hardware, that simulates a calculation capability of a biological system using a large number of artificial neurons (or nodes). The generative neural network 130 and/or the discriminative neural network 140 may perform a human cognitive operation or learning process by means of artificial neurons. The parameters associated with the generative neural network 130 and/or the discriminative neural network 140 may indicate, for example, weights assigned to a plurality of nodes included in the generative neural network 130 and/or the discriminative neural network 140 and/or connections between the plurality of nodes.

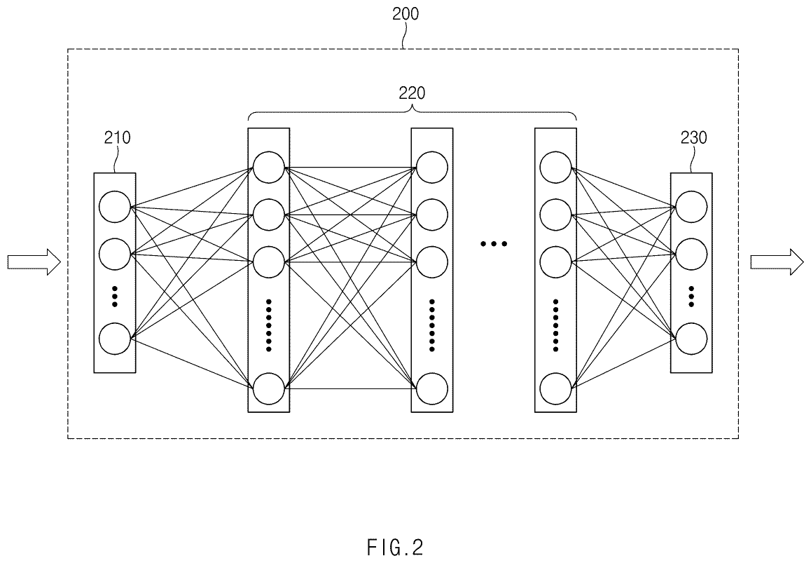

Example structure of the generative neural network 130 and/or the discriminative neural network 140 indicating the set of parameters stored in the memory 120 of the learning device 100, according to an embodiment, is described in more detail below with reference to FIG. 2. The number of the generative neural networks 130 and/or the discriminative neural networks 140 stored in the memory 120 is not limited to those shown in FIG. 1. Sets of parameters corresponding to each of the generative neural networks 130 and/or the discriminative neural networks 140 may be stored in the memory 120.

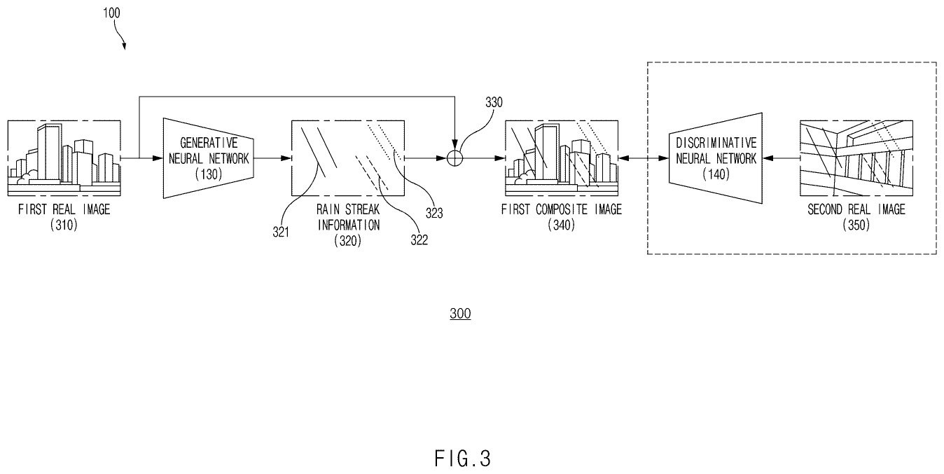

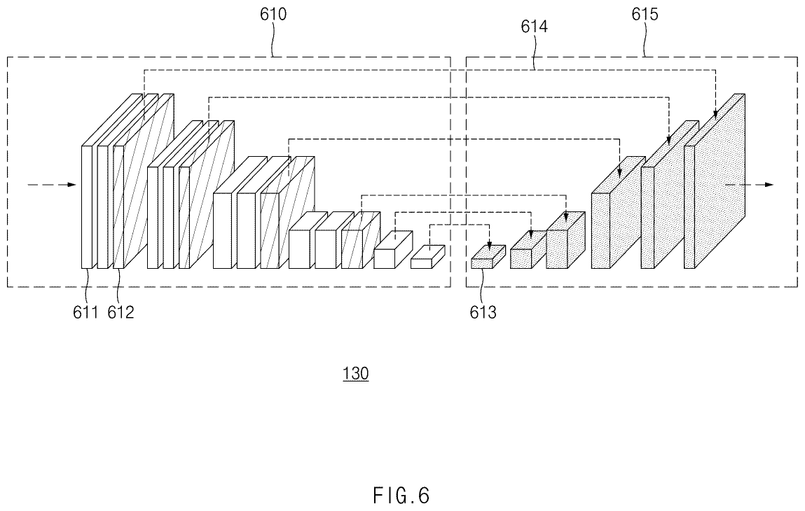

The learning device 100 according to an embodiment may obtain rain streak information indicating at least one rain streak to be synthesized with a real image, by means of the generative neural network 130. The operation of obtaining the rain streak information from the generative neural network 130 in the learning device 100, according to an embodiment, is described in more detail below with reference to FIG. 3. The generative neural network 130 may be referred to as a generator and/or a generating model. The generative neural network 130 may include one or more generative neural networks. An example structure of the generative neural network 130, according to an embodiment, is described in more detail below with reference to FIG. 6.

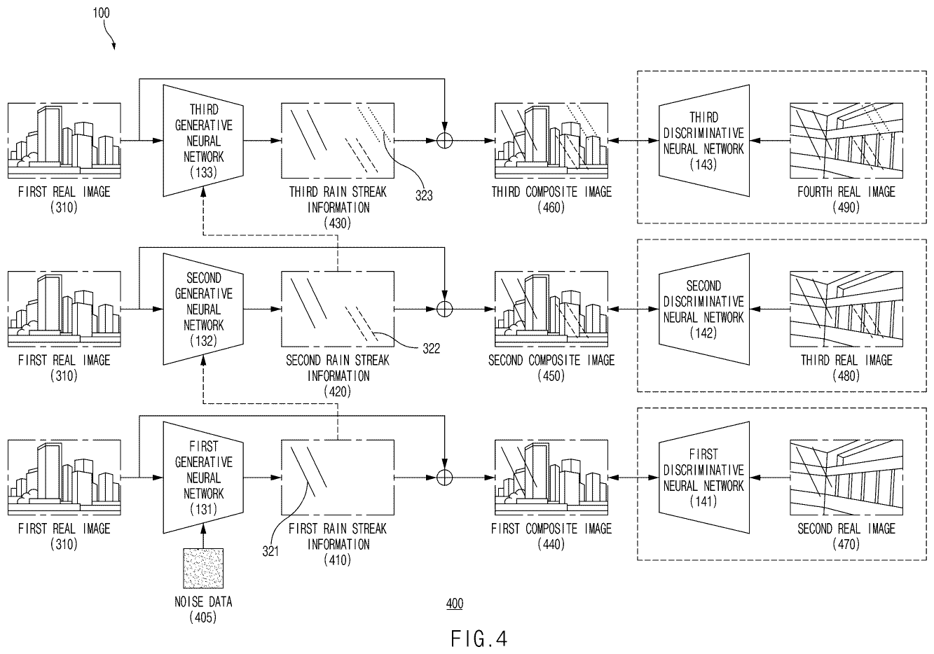

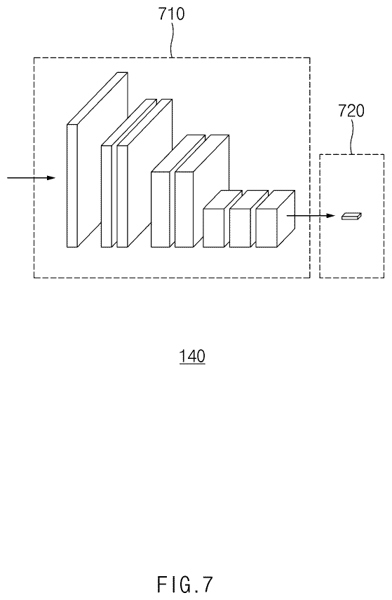

The learning device 100 according to an embodiment may discriminate a composite image obtained by applying the rain streak information obtained from the generative neural network 130 to the real image by means of the discriminative neural network 140. For example, the learning device 100 may determine whether the composite image is an image generated by the processor 110 by means of the discriminative neural network 140. As an example, the learning device 100 may determine whether the composite image is a fake image different from the real image by means of the discriminative neural network 140. The operation of determining whether there is the composite image by means of the discriminative neural network 140 in the learning device 100, according to an embodiment, is described in more detail below with reference to FIG. 4. The discriminative neural network 140 may be referred to as a discriminator and/or a discriminating model. The discriminative neural network 140 may include one or more discriminative neural networks. An structure of the discriminative neural network 140, according to an embodiment, is described in more detail below with reference to FIG. 7.

The learning device 100 according to an embodiment may obtain a score, a parameter, and/or a loss function for training the generative neural network 130 and/or the discriminative neural network 140, based on a generative adversarial network (GAN). The generative neural network 130 of the learning device 100 according to an embodiment may include a generative neural network of the GAN. The discriminative neural network 140 of the learning device 100 according to an embodiment may include a discriminative neural network of the GAN.

For example, the generative neural network 130 may be trained to identify feature information of the real image to be trained such that feature information of the composite image generated using the real image includes at least a portion of the feature information of the real image.

For example, the generative neural network 130 may be trained to output “1” or a value close to “1” from the discriminative neural network 140 to which the composite image generated based on the generative neural network 130 is input.

The learning device 100 according to an embodiment may discriminate the composite image obtained from the generative neural network 130 from the real image by means of the discriminative neural network 140. The learning device 100 according to an embodiment may train the generative neural network 130 to generate a composite image incapable of being discriminated from the real image by means of the discriminative neural network 140. The learning device 100 according to an embodiment may train the generative neural network 130 to generate a composite image to be determined as the real image by means of the discriminative neural network 140. In other words, the generative neural network 130 may generate a composite image including at least a portion of feature information corresponding to the real image, thus being trained to fool the discriminative neural network 140.

For example, when it is determined that the image input to the discriminative neural network 140 is the real image, the discriminative neural network 140 may be trained to output a specified probability value (e.g., “1” or a value close to “1”). When it is determined that the input image is the composite image, the discriminative neural network 140 may be trained to output the specified probability value (e.g., “1” or a value close to “1”). However, the present disclosure is not limited thereto.

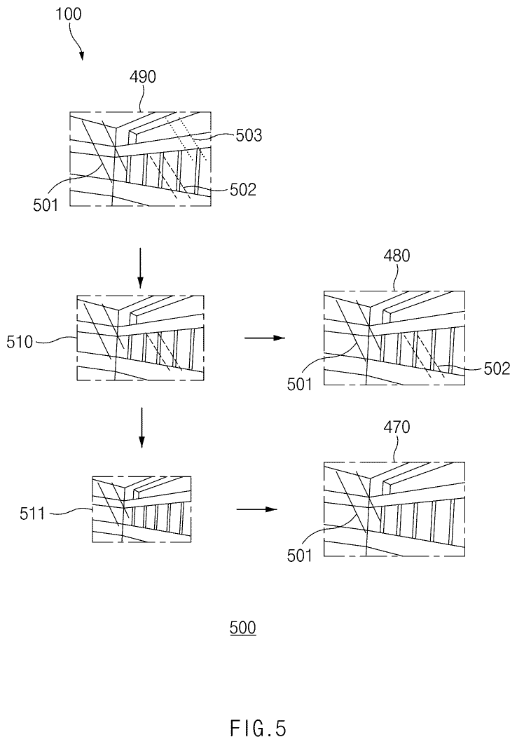

The operation of training the generative neural network 130 and/or the discriminative neural network 140 in the learning device 100, according to an embodiment, is described in more detail below with reference to FIG. 5.

Hereinafter, an example structure of a neural network the including the generative neural network 130 and discriminative neural network 140, according to an embodiment, is described in more detail with reference to FIG. 2.

FIG. 2 illustrates an example for describing a neural network obtained from a set of parameters stored in a memory by a learning device, according to an embodiment of the present disclosure. Referring to FIG. 2, at least a portion of a neural network 200 may include a plurality of layers. For example, the neural network 200 may include a generative neural network 130 and/or a discriminative neural network 140 of FIG. 1.

For example, the neural network 200 may include an input layer 210, one or more hidden layers 220, and an output layer 230. The input layer 210 may receive a vector indicating input data (e.g., a vector with elements corresponding to the number of nodes included in the input layer 210). Signals generated at each of the nodes in the input layer 210, which are generated by the input data, may be transmitted from the input layer 210 to the hidden layers 220. The output layer 230 may generate output data of the neural network 200, based on one or more signals received from the hidden layers 220. The output data may include, for example, a vector with elements corresponding to the number of the nodes included in the output layer 230.

Referring to FIG. 2, the one or more hidden layers 220 may be located between the input layer 210 and the output layer 230 and may convert input data delivered through the input layer 210 into a value easy to be predicted. The input layer 210, the one or more hidden layers 220, and the output layer 230 may include a plurality of nodes. The one or more hidden layers 220 are not limited to a shown feedforward-based topology, which may be, for example, a convolution filter or a fully connected layer in a convolutional neural network (CNN) or various types of filers or layers bound on the basis of a special function or feature. In an embodiment, the one or more hidden layers 220 may be layers based on a recurrent neural network (RNN), an output value of which is input again to the hidden layer in a current time. As an example, the input layer 210, the one or more hidden layers 220, and/or the output layer 230 may be some layers of a transformer model.

In an embodiment, the neural network 200 may include numerous hidden layers 220 and may form a deep neural network. Training the deep neural network refers to deep learning. A node included in the hidden layers 220 among the nodes of the neural network 200 refers to a hidden node.

In an embodiment, nodes included in the input layer 210 and the one or more hidden layers 220 may be connected with each other through a connection edge with a connection weight. Nodes included in the hidden layer and the output layer may also be connected with each other through the connection edge with the connection weight. Tuning and/or training the neural network 200 may refer to changing a connection weight between nodes included in each of the layers (e.g., the input layer 210, the one or more hidden layers 220, and the output layer 230) included in the neural network 200. The tuning of the neural network 200 may be performed based on, for example, supervised learning, unsupervised learning, and/or adversarial learning.

Hereinafter, an operation for applying rain streak information to a real image to obtain a composite image, using the neural network 200 in a learning device, according to an embodiment, is described in more detail below with reference to FIG. 3.

FIG. 3 is a schematic block diagram 300 of a learning device, according to an embodiment of the present disclosure. A learning device 100 of FIG. 3 may correspond to the learning device 100 of FIG. 1. Referring to FIG. 3, the learning device 100 according to an embodiment may input a first real image 310 representing fine weather to a generative neural network (e.g., the generative neural network 130). The learning device 100 may identify feature information about the first real image 310, based on object detection, semantic segmentation, and/or depth detection for the first real image 310. For example, the first real image 310 may include a dataset for training at least one neural network (e.g., a neural network associated with autonomous driving) using information about a fine weather environment. For example, the learning device 100 may input the first real image 310 including the dataset for learning the information about the fine weather environment to the generative neural network 130, thus obtaining rain streak information 320 corresponding to the first real image 310.

In an embodiment, the rain streak information 320 may indicate at least one of at least one first rain streak 321, at least one second rain streak 322, or at least one third rain streak 323, or any combination thereof. For example, the at least one first rain streak 321, the at least one second rain streak 322, and/or the at least one third rain streak 323 may have a specified length (or size), based on at least one direction. The learning device 100 may generate a rain streak (e.g., the at least one first rain streak 321, the at least one second rain streak 322, and/or the at least one third rain streak 323) based on the at least one direction, thus representing strength of the wind in rainy weather.

In an example, the at least one first rain streak 321 may be greater in size or scale than the at least one second rain streak 322. In other words, the at least one second rain streak 322 may have a smaller size than the at least one first rain streak 321. The size of at least one rain streak may include a length. As an example, the at least one second rain streak 322 may be shorter in length than the at least one first rain streak 321. At least one third rain streak 323 may be shorter in length (or size) than the at least one first rain streak 321 and/or the at least one second rain streak 322. The at least one rain streak may include raindrops with different sizes. The at least one first rain streak 321 being greater in size than the at least one second rain streak 322 may include the raindrop included in the at least one first rain streak 321 being greater in size than the raindrop included in the at least one second rain streak 322.

For example, the at least one first rain streak 321 may include the largest rain streak. The at least one third rain streak 323 may include the smallest rain streak. As an example, the at least one third rain streak 323 may indicate fog. The at least one first rain streak 321, the at least one second rain streak 322, and/or the at least one third rain streak 323 may indicate different rain intensity. The rain intensity may indicate an amount of rain. The rain intensity may vary with the number of rain streaks (or an amount of rain streaks). The learning device 100 according to an embodiment may obtain the rain streak information 320 indicating rain streaks with different sizes (or different rain intensity).

The learning device 100 according to an embodiment may synthesize the rain streak information 320 and the first real image 310 using a composite operator. The learning device 100 may synthesize the rain streak information 320 into the first real image 310 to apply the rain streaks 321, 322, and 323 to the first real image 310. The learning device 100 may obtain a first composite image 340 in which the rain streaks 321, 322, and 323 are applied to the first real image 310. For example, the learning device 100 may obtain the first composite image 340, using Equation 1 below.

$${I}_{R} = {I}_{C} + {R}_{S} + {R}_{M} + {R}_{L} \qquad [ Equation 1 ]$$

Referring to Equation 1, in an example, I_{R} may indicate the first composite image 340, I_{C} may indicate the first real image 310, R_{L} may refer to the first rain streak information indicating the at least one first rain streak 321, R_{M} may refer to the second rain streak information indicating the at least one second rain streak 322, and R_{S} may refer to the third rain streak information indicating the at least one third rain streak 323. The first rain streak information, the second rain streak information, and/or the third rain streak information may be included in the rain streak information 320. For example, the learning device 100 may synthesize the rain streak information 320 indicating rain streaks with different sizes into the first real image 310 to generate the first composite image 340 indicating more realistic rainy weather. In an example, R_{L}, R_{M}, and/or R_{S} may include different weights to represent a level of different rain intensity. For example, first rain intensity corresponding to R_{L} may be lower in level than second rain intensity corresponding to R_{M}. Third rain intensity corresponding to R_{S} may be higher in level than second rain intensity corresponding to R_{M}. As the rain intensity is higher in level, the learning device 100 may represent a larger number of rain streaks (or a larger amount of rain streaks).

The learning device 100 according to an embodiment may identify an object (e.g., a building) in the first real image 310, based on inputting the first real image 310 to the generative neural network 130. The learning device 100 may obtain object rain streak information matched with the identified object in the rain streak information 320. The learning device 100 may obtain object rain streak information, based on at least one of a color of a rain streak according to the object, a size of the rain streak, or a density of the rain streak, or any combination thereof. The learning device 100 may generate the first composite image 340 including at least a portion of the feature information included in the first real image 310, based on obtaining the object rain streak information.

The learning device 100 according to an embodiment may input the first composite image 340 to a discriminative neural network 140, based on generating the first composite image 340.

In an embodiment, the discriminative neural network 140 may be pre-trained using a second real image 350 representing rainy weather distinct to the fine weather. For example, the discriminative neural network 140 may be trained to determine whether the first composite image 340 is a synthesized image or a real image.

The learning device 100 according to an embodiment may obtain a discrimination score (e.g., any value between “0” and “1”) indicating whether the first composite image 340 is obtained based on the generative neural network 130, from the discriminative neural network 140 to which the first composite image 340 is input. The learning device 100 may perform adversarial training for the generative neural network 130 using the obtained discrimination score.

When the learning device 100 according to an embodiment obtains the rain streak information 320 indicating the rain streaks 321, 322, and 323, using the one generative neural network 130, a load for obtaining the rain streak information 320 indicating rain streak features of various sizes may be generated. The learning device 100 may obtain rain streak information indicating of each of the rain streaks 321, 322, and 323, using one or more generative neural networks trained to generate each of the rain streaks 321, 322, and 323. The operation of using the plurality of generative neural networks in the learning device 100, according to an embodiment, is described in more detail below with reference to FIG. 4.

As described above, the learning device 100 according to an embodiment may obtain the first composite image 340 representing rainy weather, using the first real image 310 representing the fine weather. The first real image 310 may include feature information (or label data) such as object detection, semantic segmentation, and/or depth detection. The learning device 100 may apply feature information corresponding to the first real image 310 to the first composite image 340 representing rainy weather. This is because the feature information of the first real image 310 is maintained, but only an environment of the first real image 310 converts from a fine weather environment to a rainy weather environment in the operation of generating the first composite image 340 representing the rainy weather. In other words, while maintaining the feature information of the first real image 310, the learning device 100 according to an embodiment may reduce a process of constructing a rainy weather training dataset including the first composite image 340 representing the rainy weather.

Hereinafter, an operation of using a plurality of neural networks to obtain rain streak information corresponding to each of the rain streaks 321, 322, and 323 in the learning device 100, according to an embodiment, is described in more detail with reference to FIG. 4.

FIG. 4 illustrates an example 400 of a generative neural network and a discriminative neural network in a learning device, according to an embodiment of the present disclosure. Referring to FIG. 4, a learning device 100 may correspond to the learning device 100 of FIG. 1.

Referring to FIG. 4, a generative neural network 130 of FIG. 3 may include a first generative neural network 131, a second generative neural network 132, and/or a third generative neural network 133. A discriminative neural network 140 of FIG. 3 may include a first discriminative neural network 141, a second discriminative neural network 142, and/or a third discriminative neural network 143. Rain streak information 320 of FIG. 3 may include first rain streak information 410, second rain streak information 420, and/or third rain streak information 430. At least one of a first composite image 440, a second composite image 450, or a third composite image 460 may be included in a first composite image 340 of FIG. 3. For example, the learning device 100 may generate a composite image from a real image, based on multi-GAN, in terms of including a plurality of generative neural networks and a plurality of discriminative neural networks. However, the present disclosure is not limited thereto.

In an embodiment, the first generative neural network 131 may include a neural network trained to generate at least one first rain streak 321 among rain streaks 321, 322, and 323. The second generative neural network 132 may include a neural network trained to generate the at least one second rain streak 322 among the rain streaks 321, 322, and 323. The third generative neural network 133 may include a neural network trained to generate at least one third rain streak 323 among the rain streaks 321, 322, and 323.

In an embodiment, the first discriminative neural network 141 may include a neural network trained using a second real image 470. The first discriminative neural network 141 may include a neural network trained to perform discrimination for the first composite image 440 in which the first rain streak information 410 is applied to a first real image 310. In an example, the second discriminative neural network 142 may include a neural network trained using a third real image 480. The second discriminative neural network 142 may include a neural network trained to perform discrimination for the second composite image 450 in which the second rain streak information 420 is applied to the first real image 310. In an example, the third discriminative neural network 143 may include a neural network trained using a fourth real image 490. The third discriminative neural network 143 may include a neural network trained to perform discrimination for the third composite image 460 in which the third rain streak information 430 is applied to the first real image 310.

The learning device 100 according to an embodiment may obtain the third real image 480 or the second real image 470, using the fourth real image 490. For example, the fourth real image 490, the third real image 480, and/or the second real image 470 may include substantially the same feature information. For example, the feature information corresponding to the fourth real image 490 may include more data than the feature information corresponding to the third feature information 480 or the feature information corresponding to the second real image 470. However, the present disclosure is not limited thereto. As an example, the fourth real image 490, the third real image 480, and/or the second real image 470 may include different pieces of feature information. The operation of obtaining the third real image 480 or the second real image 470 using the fourth real image 490 in the learning device 100, according to an embodiment, is described in more detail below with reference to FIG. 5.

The learning device 100 according to an embodiment may obtain the first rain streak information 410 indicating the at least one first rain streak 321 from the first generative neural network 131 to which the first real image 310 representing fine weather and noise data 405 are input. The noise data 405 may include data for obtaining the first composite image 440 corresponding to the first real image 310. The noise data 405 may include data for obtaining the first rain streak information 410 mapping to the first real image 310. The learning device 100 may obtain the first composite image 440 corresponding to the first real image 310, using the noise data 405.

The learning device 100 according to an embodiment may apply the first rain streak information 410 to the first real image 310 to obtain the first composite image 440. The learning device 100 may input the first composite image 440 to the first discriminative neural network 141 to train the first generative neural network 131. The learning device 100 may train the first generative neural network 131, using a loss function corresponding to the first generative neural network 131. The loss function corresponding to the first generative neural network 131 may be represented as Equation 2 below.

$${L}_{{G}_{L}} = ( {E}_{X} [ {( {D}_{L} ( {G}_{L} ( X \vert N ) ) - 1 )}^{2} ] ) \qquad [ Equation 2 ]$$

Referring to Equation 2, in an example, N may correspond to the noise data 405, X may refer to data (or simulator data) obtained by means of a generative neural network, for example, a composite image (e.g., the first composite image 440), G_{L} may correspond to the first generative neural network 131, D_{E} may correspond to the first discriminative neural network 141, E_{X} may refer to the probability value, L_{G}_{_{L}} may refer to the loss function for the first generative neural network 131, and G_{L}(X|N) may refer to R_{L} of Equation 1 above. In an example, the learning device 100 may train the first generative neural network 131, using the loss function for the first generative neural network 131. The learning device 100 may obtain the first rain streak information 410 causing a specified value (e.g., “1” or a value close to “1”) from the first discriminative neural network 141 to which the first composite image 440 is input, using the trained first generative neural network 131.

For example, the loss function corresponding to the first discriminative neural network 141 may be represented as Equation 3 below.

$${L}_{{D}_{L}} = {E}_{Y} [ {( {D}_{L} ( Y ) - 1 )}^{2} ] + {E}_{X} [ ( {{D}_{L} ( {G}_{L} ( X \vert N ) )}^{2} ] \qquad [ Equation 3 ]$$

Referring to Equation 3, in an example, Y may refer to the real data (e.g., the second real image 470) for being learned to be recognized as the true data by the discriminative neural network and L_{D}_{_{L}} may refer to the loss function corresponding to the first discriminative neural network 141.

The learning device 100 according to an embodiment may generate the at least one second rain streak 322 with a smaller size than the at least one first rain streak 321 from the second generative neural network 132 to which the first rain streak information 410 and the first real image 310 are input. The learning device 100 may obtain the second rain streak information 420 indicating the at least one second rain streak 322 and the at least one first rain streak 321.

In an embodiment, the learning device 100 may input the first rain streak information 410, output from the first generative neural network 131, to the second generative neural network 132 to obtain the second rain streak information 420 including at least a portion of the first rain streak information 410. The learning device 100 may obtain the second rain streak information 420 including at least a portion of the first rain streak information 410, based on a gradually feature fusion technique (or algorithm) which uses the first rain streak information 410 output from the first generative neural network 131. As an example, the second rain streak information 420 may include information indicating the at least one first rain streak 321 corresponding to the first rain streak information 410. The learning device 100 may train the second generative neural network 132 to generate the at least one second rain streak 322, rather than the at least one first rain streak 321, using the gradually feature fusion technique (or algorithm). The second generative neural network 132 may be trained to generate the at least one second rain streak 322 between the at least one first rain streak 321 and the at least one second rain streak 322, using the first rain streak information 410. The second generative neural network 132 may be trained to generate the at least one second rain streak 322, rather than the at least one first rain streak 321, using the first rain streak information 410. In other words, the learning device 100 may obtain the second rain streak information 420 including the first rain streak information 410, based on inputting the first rain streak information 410 obtained from the first generative neural network 131 to the second generative neural network 132.

The learning device 100 according to an embodiment may generate the second composite image 450 in which the at least one first rain streak 321 and the at least one second rain streak 322 are applied to the first real image 310, using the first real image 310 and the obtained second rain streak information 420. The learning device 100 may train the second generative neural network 132 using the second discriminative neural network 142 to which the second composite image 450 is input.

In an embodiment, the learning device 100 may identify a discrimination score for determining whether the second composite image 450 is obtained based on the second generative neural network 132, from the second discriminative neural network 142 trained using the third real image 480 representing rainy weather. The learning device 100 may perform training (e.g., adversarial training) of the second generative neural network 132 using the discrimination score. The discrimination score may include a loss function. For example, the loss function corresponding to the second generative neural network 132 may be represented as Equation 4 below.

$${L}_{{G}_{M}} = ( {E}_{X} [ {( {D}_{M} ( {G}_{M} ( X \vert {R}_{L} ) ) - 1 )}^{2} ] ) \qquad [ Equation 4 ]$$

Referring to Equation 4, in an example, G_{M} may correspond to the second generative neural network 132, D_{M} may correspond to the second discriminative neural network 142, L_{G}_{_{M}} may refer to the loss function corresponding to the second generative neural network 132, and G_{M} (X|R_{L}) may refer to R_{M} of Equation 1 above. The learning device 100 may train the second generative neural network 132 using the loss function.

For example, the loss function corresponding to the second discriminative neural network 142 may be represented as Equation 5 below.

$${L}_{{D}_{M}} = {E}_{Y} [ {( {D}_{M} ( Y ) - 1 )}^{2} ] + {E}_{X} [ ( {{D}_{M} ( {G}_{M} ( X \vert {R}_{L} ) )}^{2} ] \qquad [ Equation 5 ]$$

Referring to Equation 5, in an example, L_{D}_{_{M}} may refer to the loss function corresponding to the second discriminative neural network 142. The learning device 100 may train the second discriminative neural network 142, using a probability value (e.g., E_{X}) corresponding to the second composite image 450 obtained based on the second generative neural network 132 and a probability value (e.g., E_{Y}) corresponding to real data such as the third real image 480.

The learning device 100 according to an embodiment may obtain the third rain streak information 430 indicating the at least one third rain streak 323 with a smaller size than the at least one second rain streak 322 from the third generative neural network 133 to which the first real image 310 and the second rain streak information 420 are input. The third rain streak information 430 may include information about the at least one first rain streak 321 and/or the at least one second rain streak 322. The learning device 100 may input the second rain streak information 420 to the third generative neural network 133 to train the third generative neural network 133 to generate the at least one third rain streak 323, rather than the at least one first rain streak 321 and the at least one second rain streak 322, using the gradually feature fusion technique (or algorithm).

The learning device 100 according to an embodiment may apply the third rain streak information 430 to the first real image 310 to obtain the third composite image 460 in which the at least one first rain streak 321, the at least one second rain streak 322, and/or the at least one third rain streak 323 are synthesized. The learning device 100 may input the third composite image 460 to the third discriminative neural network 143 to obtain a discrimination score (or a loss function) for training the third generative neural network 133 from the third discriminative neural network 143. Each of the at least one first rain streak 321, the at least one second rain streak 322, and the at least one third rain streak 323 may correspond to a different weight.

In an embodiment, the loss function corresponding to the third generative neural network 133 may be represented as Equation 6 below.

$${L}_{{G}_{S}} = ( {E}_{X} [ {( {D}_{S} ( {G}_{S} ( X \vert {R}_{M} ) ) - 1 )}^{2} ] ) \qquad [ Equation 6 ]$$

Referring to Equation 6, in an example, R_{M} may refer to the second rain streak information 420, G_{S} may refer to the third generative neural 133, Ds may refer to the third discriminative neural network 143, G_{S} (X|R_{M}) may correspond to R_{S} of Equation 1 above, and L_{G}_{_{S}} may refer to the loss function corresponding to the third generative neural network 133. The learning device 100 may train the third generative neural network 133, using the loss function. When inputting the third composite image 460 obtained using the trained third generative neural network 133 to the third discriminative neural network 143, the third discriminative neural network 143 may output a specified value (e.g., “1” or a value close to “1”). However, the present disclosure is not limited thereto.

For example, the third generative neural network 143 may be trained using Equation 7 below.

$${L}_{{D}_{S}} = {E}_{Y} [ {( {D}_{S} ( Y ) - 1 )}^{2} ] + {E}_{X} [ ( {{D}_{S} ( {G}_{S} ( X \vert {R}_{M} ) )}^{2} ] \qquad [ Equation 7 ]$$

Referring to Equation 7, in an example, L_{D}_{_{S}} may refer to the loss function corresponding to the third discriminative neural network 143. The learning device 100 may train the third discriminative neural network 143 to discriminate whether the image synthesized by means of the third discriminative neural network 143 is a real image, using the loss function.

The learning device 100 according to an embodiment may obtain a loss function for tuning all generative neural networks (e.g., the generative neural network 130 of FIG. 1). For example, the learning device 100 may identify a loss function for tuning all the generative neural networks, using Equation 8 below.

$${L}_{G} = \frac{1}{3} ( {L}_{{G}_{L}} + {L}_{{G}_{M}} + {L}_{{G}_{S}} ) \qquad [ Equation 8 ]$$

Referring to Equation 8, in an example, L_{G} may refer to the average of the loss functions respectively corresponding to the generative neural networks 131, 132, and 133. The learning device 100 may train all the generative neural networks, using L_{G}. However, the present disclosure is not limited thereto.

The learning device 100 according to an embodiment may obtain a loss function for tuning all discriminative neural networks (e.g., the discriminative neural network 140 of FIG. 1). For example, the learning device 100 may obtain a loss function for turning all the discriminative neural network, using Equation 9 below.

$${L}_{D} = \frac{1}{3} ( {L}_{{D}_{L}} + {L}_{{D}_{M}} + {L}_{{D}_{S}} ) \qquad [ Equation 9 ]$$

Referring to Equation 9, in an example, L_{D} may refer to the average of the loss functions respectively corresponding to the discriminative neural networks 141, 142, and 143. The learning device 100 may train all the discriminative neural networks, using L_{D}. However, the present disclosure is not limited thereto.

In an embodiment, the first rain streak information 410 may indicate first rain intensity, based on the at least one first rain streak 321. The second rain streak information 420 may indicate second rain intensity, based on the at least one first rain streak 321 and the at least one second rain streak 322. The third rain streak information 430 may indicate third rain intensity, based on the at least one first rain streak 321, the at least one second rain streak 322, and/or the at least one third rain streak 323.

For example, the third rain intensity may be higher in level than the second rain intensity. The second rain intensity may be higher in level than the first rain intensity. For example, the more the number of rain streaks increases, the higher the rain intensity may be in level. As an example, the second rain intensity may indicate a rain streak with a number (or an amount) greater than the number of rain streaks (or an amount of the rain streaks) corresponding to the first rain intensity. As an example, the learning device 100 may change data indicating contrast to obtain the at least one first rain streak 321, the at least one second rain streak 322, and/or the at least one third rain streak 323, which have different contrast.

As described above, the learning device 100 according to an embodiment may obtain a composite image representing rainy weather from a real image representing fine weather, using the trained generative neural network. The learning device 100 may use the plurality of generative neural networks 131, 132, and 133 to generate rain streaks with various sizes. The learning device 100 may train the plurality of generative neural networks 131, 132, and 133 to generate rain streaks respectively corresponding to the plurality of generative neural networks 131, 132, and 133. The learning device 100 may be trained to generate the rain streaks respectively corresponding to the plurality of generative neural networks 131, 132, and 133, thus more reducing an amount of load than generating rain streaks with various sizes using one generative neural network.

Hereinafter, the operation of resizing the fourth real image 490 to obtain the third real image 480 and/or the second real image 470 in the learning device 100, according to an embodiment, is described in more detail with reference to FIG. 5.

FIG. 5 illustrates an example 500 of an operation for obtaining a real image indicating rainy weather in a learning device, according to an embodiment of the present disclosure. A learning device 100 of FIG. 5 may correspond to a learning device 100 of FIG. 1.

Referring to FIG. 5, based on resizing a fourth real image 490 representing rainy weather distinct to fine weather, the learning device 100 according to an embodiment may obtain a third real image 480 or a second real image 470 representing another rainy weather distinct to the rainy weather.

In an embodiment, the fourth real image 490 may include an image which is distinct to a first real image (e.g., a first real image 310 of FIG. 3) representing fine weather and indicating a rainy weather environment.

For example, the fourth real image 490 may include rain streaks 501, 502, and 503. The rain streaks 501, 502, and 503 may have various sizes. For example, the first rain streak 501 may include at least a portion of feature information corresponding to at least one first rain streak 321 of FIG. 4. As an example, a size of the first rain streak 501 may correspond to a size of the at least one first rain streak 321 of FIG. 4. For example, the second rain streak 502 may include at least a portion of feature information corresponding to at least one second rain streak 322 of FIG. 4. As an example, a size of the second rain streak 502 may correspond to a size of the at least one second rain streak 322 of FIG. 4. For example, the third rain streak 503 feature information may include at least a portion of corresponding to at least one third rain streak 323 of FIG. 4. As an example, a size of the third rain streak 503 may correspond to a size of the at least one third rain streak 323 of FIG. 4. The rain streaks 501, 502, and 503 may refer to rain streaks included in a real rain environment. The learning device 100 according to an embodiment may train a discriminative neural network (e.g., a discriminative neural network 140 of FIG. 1), using at least one of the real images 470, 480, and 490 including at least one of the rain streaks 501, 502, and 503.

The learning device 100 according to an embodiment may obtain a first downsampling image 510, using downsampling of the fourth real image 490. The learning device 100 may remove at least one of pixels included in the fourth real image 490 to obtain the first downsampling image 510.

The learning device 100 according to an embodiment may apply a Gaussian filter or a Laplacian filter to the fourth real image 490 to obtain the first downsampling image 510. The learning device 100 may remove (or filter) a relatively high frequency among frequencies corresponding to the fourth real image 490 to obtain the first downsampling image 510, based on the Gaussian filter or the Laplacian filter. For example, the first downsampling image 510 may be smaller in size than the fourth real image 490.

The learning device 100 according to an embodiment may downsample the fourth real image 490, based on broadening an interval between pixels included in the fourth real image 490. The learning device 100 may obtain the first downsampling image 510 from the fourth real image 490, based on average pooling or max pooling. For example, capacity corresponding to the first downsampling image 510 may be smaller than capacity corresponding to the fourth real image 490.

The learning device 100 according to an embodiment may obtain the third real image 480, by means of upsampling of the first downsampling image 510. The learning device 100 may correct pixels included in the first downsampling image 510, using an interpolation technique. For example, the interpolation technique may include nearest neighbor interpolation, bilinear interpolation, bicubic interpolation, and/or Lanczos interpolation. The learning device 100 may enlarge the size of the first downsampling image 510 to correspond to the size of the fourth real image 490, using the interpolation technique. The enlarged first downsampling image 510 may correspond to the third real image 480.

For example, the third real image 480 may be obtained based on downsampling the fourth real image 490 and upsampling the downsampled fourth real image 490 (e.g., the first downsampling image 510). Because the third real image 480 is obtained based on downsampling the fourth real image 490, feature information corresponding to the third real image 480 may include relatively less information than feature information corresponding to the fourth real image 490.

For example, because of downsampling the fourth real image 490 including the rain streaks 501, 502, and 503, the learning device 100 may identify the first rain streak 501 and the second rain streak 502 among the rain streaks 501, 502, and 503. As an example, the third real image 480 may include the first rain streak 501 and the second rain streak 502, except for the relatively smallest third rain streak 503, among the rain streaks 501, 502, and 503 included in the fourth real image 490. However, the present disclosure is not limited thereto.

The learning device 100 according to an embodiment may downsample the first downsampling image 510, independently of obtaining the third real image 480 from the first downsampling image 510. The operation of obtaining the second downsampling image 511 from the first downsampling image 510 in the learning device 100 according to an embodiment may correspond to an operation of obtaining the first downsampling image 510 from the fourth real image 490. The second downsampling image 511 may have a relatively smaller size or capacity than the first downsampling image 510.

The learning device 100 according to an embodiment may obtain the second real image 470, based on upsampling of the second downsampling image 511. For example, when performing object detection for the second real image 470, the learning device 100 may identify the first rain streak 501 among the rain streaks 501, 502, and 503. As an example, the second real image 470 may include the relatively largest first rain streak 501 among the rain streaks 501, 502, and 503. Because the relatively largest first rain streak 501 among the rain streaks 501, 502, and 503 is relatively larger than the other rain streaks 502 and 503, it may have relatively more feature information. Because the second real image 470 is obtained based on downsampling the fourth real image 490 including the rain streaks 501, 502, and 503, the learning device 100 may identify the first rain streak 501 with relatively more feature information among the rain streaks 501, 502, and 503, using the second real image 470.

The learning device 100 according to an embodiment may train a first discriminative neural network (e.g., a first discriminative neural network 141 of FIG. 4), using the second real image 470 including the first rain streak 501. The first discriminative neural network may be trained to discriminate at least one first rain streak (e.g., at least one first rain streak 321 of FIG. 3) corresponding to the relatively largest first rain streak 501, using the second real image 470.

The learning device 100 according to an embodiment may train a second discriminative neural network (e.g., a second discriminative neural network 142 of FIG. 4), using the third real image 480 including the first rain streak 501 and the second rain streak 502. The second discriminative neural network may be trained to discriminate each of at least one first rain streak (e.g., at least one first rain streak 321 of FIG. 3) and at least one second rain streak (e.g., at least one second rain streak 322 of FIG. 3) respectively corresponding to the first rain streak 501 and the second rain streak 502, using the third real image 480.

For example, because the first discriminative neural network (e.g., the first discriminative neural network 141 of FIG. 3) is trained to discriminate the largest first rain streak 501, the second discriminative neural network (e.g., the second discriminative neural network 142 of FIG. 3) may be trained to discriminate the second rain streak 502 between the first rain streak 501 and the second rain streak 502. However, the present disclosure is not limited thereto.

The learning device 100 according to an embodiment may train a third discriminative neural network (e.g., a third discriminative neural network 143 of FIG. 4), using the fourth real image 490 including the first rain streak 501, the second rain streak 502, and the third rain streak 503. The third discriminative neural network may be trained to discriminate each of the at least one first rain streak (e.g., the at least one first rain streak 321 of FIG. 3), the at least one second rain streak (e.g., the at least one second rain streak 322 of FIG. 3), and the at least one third rain streak (e.g., the at least one third rain streak 323 of FIG. 3) respectively corresponding to the first rain streak 501, the second rain streak 502, and the third rain streak 503, using the four real image 490. For example, the third discriminative neural network may be trained to discriminate the smallest third rain streak 503 among the rain streaks 501, 502, and 503. However, the present disclosure is not limited thereto.

As described above, based on at least one of downsampling or upsampling for a real image (e.g., the fourth real image 490) representing rainy weather, or any combination thereof, the learning device 100 according to an embodiment may obtain another real image (e.g., the third real image 480 or the second real image 470) representing another rainy weather. The other rainy weather may indicate an environment in which a relatively small rain streak among types of rain streaks included in the rainy weather is removed.

The learning device 100 according to an embodiment may train a discriminative neural network, using u a real image including at least one of the rain streaks 501, 502, and 503 with different sizes. The learning device 100 may perform adversarial training of a generative neural network for generating rain streak information indicating at least one of rain streaks (e.g., the at least one first rain streak 321, the at least one second rain streak 322, and the at least one third rain streak 323 of FIG. 3) with different sizes, using the trained discriminative neural network. The learning device 100 may generate a composite image including at least a portion of feature information of a real image representing real rainy weather, using the trained generative neural network. Based on the generating the composite image, the learning device 100 may obtain a dataset for training a neural network associated with autonomous driving.

Hereinafter, an example structure of layers included in a generative neural network and a discriminative neural network, according to an embodiment, is described in more detail with reference to FIGS. 6 and 7.

FIG. 6 illustrates an example for describing a configuration of a generative neural network, in an embodiment. FIG. 7 illustrates an example for describing a configuration of a discriminative neural network, in an embodiment. A generative neural network 130 of FIG. 6 may correspond to the generative neural network 130 of FIG. 1. A discriminative neural network 140 of FIG. 7 may correspond to the discriminative neural network 140 of FIG. 1. Referring to FIG. 6, the generative neural network 130 may be composed of a U-NET model which is an image segmentation algorithm. The U-NET model may be an example of an encoder-decoder-based model. The learning device 100 may increase the number of channels or may reduce an embedded data dimension to identify a feature of an image input to an encoder 610, using the encoder 610. The learning device 100 may decrease the number of channels and increase a dimension using information encoded into a low dimension to recover a high-dimensional image, using a decoder 615. In other words, the U-NET model may be an example of a neural network for extracting a feature of an image by using low-dimensional information high-dimensional information together and simultaneously ascertaining an accurate position for an image object.

Referring to FIG. 6, the learning device 100 according to an embodiment may apply an image input to the encoder 610 of the generative neural network 130 to a convolution block 611 including a convolution filter and/or a rectified linear unit (ReLU) activation function, using the encoder 610. The learning device 100 may pass the image to which the convolution block 611 is applied through a residual block 612 to extract a deep feature for the image to which the convolution block 611 is applied. The encoder 610 may include one or more convolution blocks. The encoder 610 may include one or more residual blocks.

The decoder 615 of the learning device 100 according to an embodiment may include one or more residual blocks 613. The learning device 100 may apply data output from each of respective blocks (e.g., the convolution block 611 or the residual block 612) included in the encoder 610 to the decoder 615, based on a skip connection 614. Thereafter, the learning device 100 may upsample an output value of the decoder 615 to output an image based on resolution, for example, the image input to the encoder 610.

Referring to FIG. 7, the learning device 100 may obtain feature information by applying an image input to the discriminative neural network 140 to a leaky convolution block 710 including a convolution filter and a leaky rectified linear unit (LeakyReLU) activation function.

The learning device 100 according to an embodiment may apply the obtained feature information to a fully connected layer 720 to output an authenticity probability (e.g., a value between “O” and “1”) of the input image. The authenticity probability may be output as a value between “0” and “1”.

For example, as the output value output from the discriminative neural network 140 is close to “0”, the learning device 100 may discriminate the input image as a fake image (e.g., a composite image 460 of FIG. 4). For example, as the output value output from the discriminative neural network 140 is close to “1”, the learning device 100 may discriminate the input image as a real image (e.g., a fourth real image 490). However, the present disclosure is not limited thereto.

As described above, the learning device 100 according to an embodiment may generate a composite image (e.g., a third composite image 460 of FIG. 3) representing rainy weather, which is obtained using the generative neural network 130 and the discriminative neural network 140. The composite image may be used as training data for training a deep learning model associated with autonomous driving. By using label data of a real image used to generate the composite image without change to generate the composite image, the learning device 100 may provide the effect of simplifying the operation of generating training data.

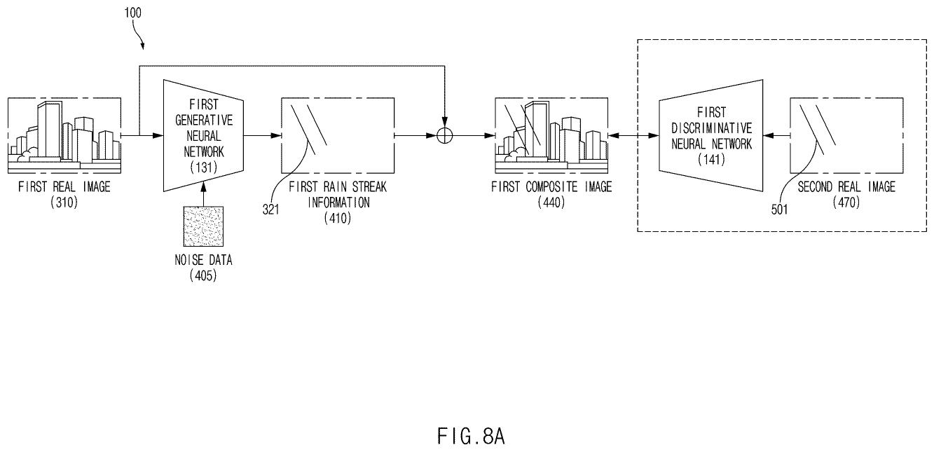

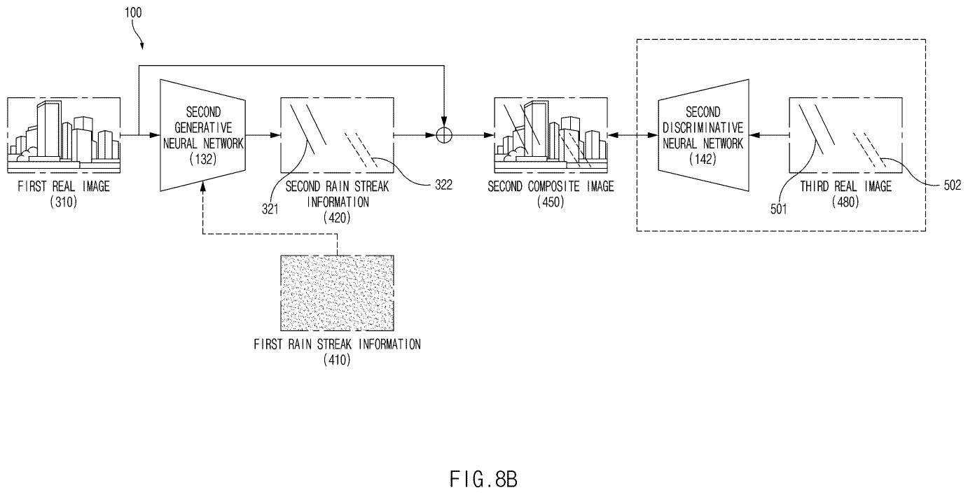

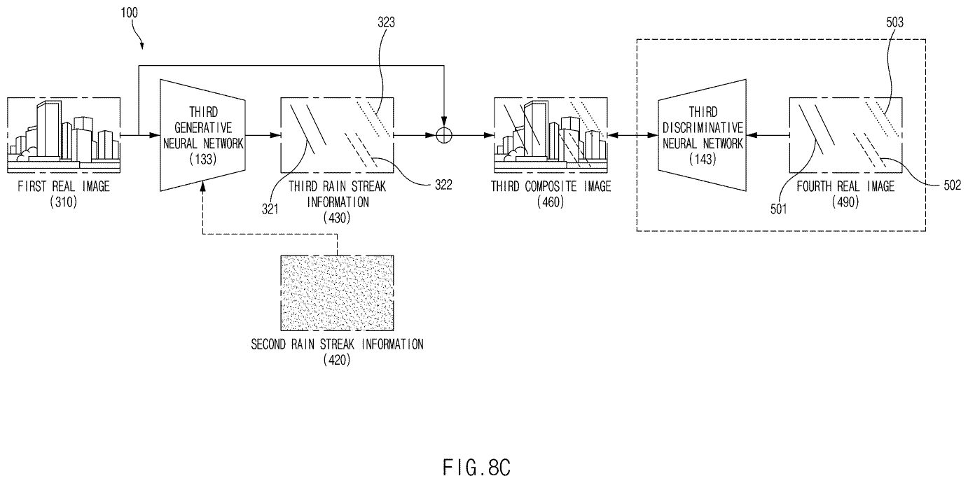

FIGS. 8A-8C illustrate an example of an operation for obtaining a composite image using a real image and rain streak information in a learning device, according to an embodiment of the present disclosure. A learning device 100 of FIGS. 8A-8C may correspond to the learning device 100 of FIG. 1.

Referring to FIG. 8A, the learning device 100 according to an embodiment may input a first real image 310 representing fine weather and noise data 405 to a first generative neural network 131. The noise data 405 may be used to generate first rain streak information 410 corresponding to the first real image 310. The first rain streak information 410 corresponding to the first real image 310 may include at least one first rain streak 321 respectively corresponding to objects included in the first real image 310. As an example, a rain streak corresponding to a first object (e.g., a building) included in the first real image 310 may differ in color from a rain streak corresponding to a second object (e.g., the sky). The first rain streak information 410 may indicate the at least one first rain streak 321. For example, the first generative neural network 131 may be referred to as a large rain generator in terms of generating the largest rain.

The learning device 100 according to an embodiment may synthesize the first real image 310 and the first rain streak information 410 to obtain a first composite image 440. The learning device 100 may output an authenticity probability (or a discrimination score) for the first composite image 440, using the first discriminative neural network 141 trained using a second real image 470 including a first rain streak 501. The learning device 100 may train the first generative neural network 131, based on the output authenticity probability.

As described above, the learning device 100 according to an embodiment may generate the first rain streak information 410 rather than the first composite image 440 based on residual learning, using the noise data 405, by means of the first generative neural network 131, thus providing the effect of reducing the amount of load of the first generative neural network 131.

Referring to FIG. 8B, the learning device 100 according to an embodiment may transmit the first real image 310 and the first rain streak information 410 to a second generative neural network 132. The learning device 100 may obtain second rain streak information 420 indicating the at least one first rain streak 321 and at least one second rain streak 322, using the second generative neural network 132. Because of transmitting the first rain streak information 410 to the second generative neural network 132, the learning device 100 may generate the at least one second rain streak 322 between the at least one first rain streak 321 and the at least one second rain streak 322, using the second generative neural network 132. As an example, the learning device 100 may generate the at least one second rain streak 322, using another area distinct to an area corresponding to the at least one first rain streak 321, to obtain the second rain streak information 420. For example, the second generative neural network 132 may be referred to as an intermediate rain generator in terms of generating the at least one second rain streak 322 with a size which is smaller than the at least one first rain streak 321 and is greater than at least one third rain streak 323.

The learning device 100 according to an embodiment may apply the second rain streak information 420 to the first real image 310 to obtain a second composite image 450. The learning device 100 may check whether the second composite image 450 is authentic, using a second discriminative neural network 142 trained based on a third real image 480 including a first rain streak 501 and a second rain streak 502. The learning device 100 may train the second generative neural network 132, using a discrimination score output from the second discriminative neural network 142.

As described above, the learning device 100 according to an embodiment may transmit the first rain streak information 410 indicating the at least one first rain streak 321 to the second generative neural network 132. Because information indicating the at least one first rain streak 321 is included in the first rain streak information 410, the learning device 100 may perform learning for generating the at least one second rain streak 322, using the second generative neural network 132.

Referring to FIG. 8C, the learning device 100 according to an embodiment may generate third rain streak information 430, rather than a third composite image 460, by means of the third generative neural network 133, using the first real image 310 and the second rain streak information 420. The third rain streak information 430 may indicate the at least one first rain streak 321, the at least one second rain streak 322, and/or at least one third rain streak 323.

Because of using the second rain streak information 420 output from the second generative neural network 132, the learning device 100 according to an embodiment may generate the at least one third rain streak 323 among the at least one first rain streak 321, the at least one second rain streak 322, and the at least one third rain streak 323, by means of the third generative neural network 133. For example, the third generative neural network 133 may be referred to as a small rain generator in terms of generating the smallest rain.

The learning device 100 according to an embodiment may synthesize the third rain streak information 430 with the first real image 310 to obtain the third composite image 460 including the at least one first rain streak 321, the at least one second rain streak 322, and/or the at least one third rain streak 323. For example, the learning device 100 according to an embodiment may obtain the third composite image 460, based on overlaying the at least one first rain streak 321, the at least one second rain streak 322, and/or the at least one third rain streak 323 on the first real image 310. However, the present disclosure is not limited thereto.

The learning device 100 according corresponding to embodiment may obtain a discrimination score corresponding to the third composite image 460, using the third discriminative neural network 143 to which the third composite image 460 is input. The third discriminative neural network 143 may include a neural network trained using a fourth real image 490 including a first rain streak 501, a second rain streak 502, and/or a third rain streak 503. For example, the third discriminative neural network 143 may be an example of a neural network trained to output an authenticity probability for the at least one third rain streak 323 corresponding to the third rain streak 503. However, the present disclosure is not limited thereto. For example, the learning device 100 may train the third generative neural network 133, using the discrimination score output from the third discriminative neural network 143.

The learning device 100 according to an embodiment may generate a training dataset representing rainy weather by using feature information of a training dataset representing fine weather without change, by means of the first generative neural network 131, the second generative neural network 132, and/or the third generative neural network 133, which are/is trained.

As described above, the learning device 100 according to an embodiment may apply the at least one rain streak (321, 322, and 323) with various sizes to a real image representing fine weather to obtain a composite image. Because of including at least one rain streak with various sizes, the composite image may more accurately represent real rainy weather. The learning device 100 may generate a training dataset representing rainy weather by means of a training dataset representing fine weather, thus providing a service for generating a training dataset indicating various real environments.

Hereinafter a learning method, according to an embodiment of the present disclosure, is described in more detail with reference to FIG. 9.

FIG. 9 is a flowchart illustrating example operation of a learning device, according to an embodiment of the present disclosure. The respective operations of FIG. 9 may be sequentially performed, but are not necessarily sequentially performed. For example, an order of the respective operations may be changed, and at least two operations may be performed in parallel. Hereinafter, it is assumed that a learning device 100 of FIG. 1 performs a process of FIG. 9. Furthermore, in a description of FIG. 9, it may be understood that an operation described as being performed by a device is controlled by a processor 110 of the learning device 100.

Referring to FIG. 9, in an operation S910, the learning device 100 according to an embodiment may obtain first rain streak information indicating at least one first rain streak from a first generative neural network to which a real image representing fine weather and noise data are input. Obtaining the first rain streak information generating the first rain streak information, rather than a composite image, based on residual learning using the first generative neural network to which the noise data is input together with the real image. The first rain streak information may indicate first rain intensity, depending on the number (or the amount) of the at least one first rain streak.

The learning device 100 according to an embodiment may generate a composite image in which the at least one rain streak is applied to the real image, using the real image and the first rain streak information. The composite image to which the at least one first rain streak is applied may correspond to a first composite image 440 of FIG. 4.

For example, the learning device 100 may obtain a discrimination score indicating whether the composite image is authentic from a first discriminative neural network (e.g., a first discriminative neural network 141 of FIG. 4) trained using a second real image (e.g., a second real image 470 of FIG. 4) representing rainy weather. The learning device 100 may tune the first generative neural network using the discrimination score.

Referring again to FIG. 9, in an operation S920, the learning device 100 according to an embodiment may obtain second rain streak information indicating at least one second rain streak from a second generative neural network to which the first rain streak information and the real image are input. The second generative neural network may be an example of a trained neural network to generate at least one second rain streak between the at least one first rain streak and the at least one second rain streak, using the first rain streak information. For example, obtaining the second rain streak information may include obtaining the second rain streak information including at least a portion of the first rain streak information, based on inputting the first rain streak information to the second generative neural network. The second rain streak information may include information indicating the at least one second rain streak corresponding to an object in the real image. The second rain streak information may indicate second rain intensity with a higher level than the rain intensity. The second rain streak information may indicate the second rain intensity based on the at least one first rain streak and the at least one second rain streak. Because the first rain streak information represents the first rain intensity using the at least one first rain streak and the second rain streak information represents the second rain intensity using the at least one first rain streak and the at least one second rain streak, the first rain intensity may be lower in level than the second rain intensity. However, the present disclosure is not limited thereto.

Referring still to FIG. 9, in an operation S930, the learning device 100 according to an embodiment may generate a composite image in which the at least one first rain streak and the at least one second rain streak are applied to the real image, using the real image and the second rain streak information. The learning device 100 according to an embodiment may obtain a discrimination score indicating an authenticity probability for the composite image from a second discriminative neural network (e.g., a second discriminative neural network 142 of FIG. 4) trained using a third real image (e.g., a third real image 480 of FIG. 4). The learning device 100 according to an embodiment may perform adversarial training for the second generative neural network using the discrimination score. The learning device 100 according to an embodiment may generate a composite image representing rainy weather from a real image representing fine weather, using the trained first generative neural network and the trained second generative neural network.

According to embodiments of the present disclosure, a learning device may generate a composite image representing rainy weather from a real image representing fine weather.

Furthermore, according to embodiments of the present disclosure, a learning device may generate a composite image representing rainy weather based on different rain streaks by using label data of a real image representing fine weather.

Furthermore, according to embodiments of the present disclosure, a learning device may train generative neural networks based on multi-generative adversarial networks (multi-GAN) to generate different rain streaks.

In addition, various effects ascertained directly or indirectly through the present disclosure may be provided.

Hereinabove, although the present disclosure has been described with reference to certain embodiments and the accompanying drawings, the present disclosure is not limited thereto, but may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A learning device, comprising:
a processor; and
a memory operably connected to the processor,
wherein the processor is configured to
obtain first rain streak information indicating first rain intensity from a first generative neural network to which a real image representing fine weather and noise data are input,
obtain second rain streak information indicating second rain intensity with a higher level than the first rain intensity from a second generative neural network to which the first rain streak information and the real image are input, and
generate a composite image in which a rain streak representing the second rain intensity is applied to the real image, using the real image and the second rain streak information.

2. The learning device of claim 1, wherein:
the real image includes a first real image;
the composite image includes a first composite image;
the rain streak includes at least one first rain streak representing the first rain intensity; and
the processor is further configured to
generate a second composite image in which the at least one first rain streak is applied to the first real image, using the real image and the first rain streak information;
obtain a first discrimination score indicating whether the second composite image is obtained based on the first generative neural network, from a first discriminative neural network trained using a second real image representing rainy weather distinct to the fine weather; and
perform adversarial training for the first generative neural network, using the first discrimination score.

3. The learning device of claim 2, wherein the processor is configured to:
obtain a second discrimination score for determining whether the first composite image is obtained based on the second generative neural network, from a second discriminative neural network trained using a third real image representing another rainy weather distinct to the rainy weather; and
perform adversarial training for the second generative neural network, using the second discrimination score.

4. The learning device of claim 3, wherein the second real image is obtained based on upsampling a downsampled third real image, after the third real image is downsampled.

5. The learning device of claim 2, wherein:
the noise data includes data for obtaining the first composite image corresponding to the first real image; and
the processor is configured to generate the first rain streak information, based on residual learning using the first generative neural network to which the noise data is input together with the first real image.

6. The learning device of claim 5, wherein the processor is configured to:
identify an object in the first real image, based on inputting the first real image to the first generative neural network;
obtain object rain streak information matched with the object in the first rain streak information; and
generate the second composite image including at least a portion of feature information included in the first real image, based on obtaining the object rain streak information.

7. The learning device of claim 2, wherein the second generative neural network is trained to generate at least one second rain streak with a smaller size than the at least one first rain streak between the at least one first rain streak and the at least one second rain streak, using the first rain streak information.

8. The learning device of claim 2, wherein the processor is configured to:
obtain the second rain streak information including the at least one first rain streak and at least one second rain streak with a smaller size than the at least one first rain streak, based on inputting the first rain streak information obtained from the first generative neural network to the second generative neural network.

9. The learning device of claim 8, wherein the processor is configured to:
obtain third rain streak information including at least one third rain streak with a smaller size than the at least one second rain streak from a third generative neural network to which the real image and the second rain streak information are input.

10. The learning device of claim 1, wherein the second rain intensity has a higher level than the first rain intensity, based on representing the rain streak with a rain streak number greater than a number of rain streaks corresponding to the first rain intensity.

11. A learning method, comprising:
obtaining first rain streak information indicating first rain intensity from a first generative neural network to which a real image representing fine weather and noise data are input;
obtaining second rain streak information indicating second rain intensity with a higher level than the first rain intensity from a second generative neural network to which the first rain streak information and the real image are input; and
generating a composite image in which a rain streak representing the second rain intensity is applied to the real image, using the real image and the second rain streak information.

12. The learning method of claim 11, wherein:
the real image includes a first real image,
the composite image includes a first composite image, the rain streak includes at least one first rain streak representing the first rain intensity, and
the method further comprises
generating a second composite image in which the at least one first rain streak is applied to the first real image, using the real image and the first rain streak information, obtaining a first discrimination score indicating whether the second composite image is obtained based on the first generative neural network, from a first discriminative neural network trained using a second real image representing rainy weather distinct to the fine weather, and
performing adversarial training for the first generative neural network, using the first discrimination score.

13. The learning method of claim 12, further comprising:
obtaining a second discrimination score for determining whether the first composite image is obtained based on the second generative neural network, from a second discriminative neural network trained using a third real image representing another rainy weather distinct to the rainy weather; and
performing adversarial training for the second generative neural network, using the second discrimination score.

14. The learning method of claim 13, wherein the second real image is obtained based on upsampling a downsampled third real image, after the third real image is downsampled.

15. The learning method of claim 12, wherein:
the noise data includes data for obtaining the first composite image corresponding to the first real image; and
obtaining the first rain streak information includes generating the first rain streak information between the second composite image and the first rain streak information, based on residual learning using the first generative neural network to which the noise data is input together with the first real image.

16. The learning method of claim 15, further comprising:
identifying an object in the first real image, based on inputting the first real image to the first generative neural network;
obtaining object rain streak information matched with the object in the first rain streak information; and
generating the second composite image including at least a portion of feature information included in the first real image, based on obtaining the object rain streak information.

17. The learning method of claim 12, wherein the second generative neural network is trained to generate at least one second rain streak with a smaller size than the at least one first rain streak between the at least one first rain streak and the at least one second rain streak, using the first rain streak information.

18. The learning method of claim 12, wherein obtaining the second rain streak information includes obtaining the second rain streak information including the at least one first rain streak and at least one second rain streak with a smaller size than the at least one first rain streak, based on inputting the first rain streak information obtained from the first generative neural network to the second generative neural network.

19. The learning method of claim 18, further comprising:
obtaining third rain streak information indicating at least one third rain streak with a smaller size than the at least one second rain streak from a third generative neural network to which the real image and the second rain streak information are input.

20. The learning method of claim 11, wherein the second rain intensity has a higher level than the first rain intensity, based on representing the rain streak with a rain streak number greater than a number of rain streaks corresponding to the first rain intensity.
